(19) United States
(12) Patent Application Publication
(10) Pub. No.: US 2007/0029403 A1
(43) Pub. Date: Feb. 8, 2007

(54) Dual point active flow control system for controlling air vehicle attitude during transonic flight

(75) Inventors: Ahmed A. Hassan, Mesa, AZ (US); Garrett M. Billman, Troy, MO (US); Casey L. Madsen, St. Charles, MO (US)

Correspondence Address: LEE & HAYES, PLLC, 421 W. RIVERSIDE AVE., SUITE 500, SPOKANE, WA, 99201, US

(73) Assignee: The Boeing Company

(21) Appl. No.: 11/188,386

(22) Filed: Jul. 25, 2005

(51) Int. Cl. A62C 27/00; A62C 25/00; B64D 1/18

(52) U.S. Cl. 239/171; 169/52; 169/53

(57) ABSTRACT

An air vehicle having a fuselage and two wings extending laterally therefrom and having a first surface between leading and trailing edges and an opposite second surface. The vehicle includes adjacent upstream and downstream orifices positioned on at least one first surface. Each upstream orifice is closer to the leading edge than the downstream orifice. Each second surface is substantially free of orifices. The vehicle includes an actuator within each wing having orifices. Each actuator is connected to corresponding upstream and downstream orifices for creating a negative pressure differential at the upstream orifice and a positive pressure differential at the downstream orifice so air is drawn into the upstream orifice and air is pushed away form the downstream orifice. The orifice is configured so air is drawn into and directed out of the upstream and downstream orifices, respectively, at an angle of about 90% with respect to the first surface.

### BACKGROUND OF THE INVENTION

The present invention relates to air vehicles and, more particularly, to air vehicles having an active flow control system for controlling vehicle attitude during transonic flight.

Attitude of air vehicles, including aircraft and missiles, is typically controlled using systems having aerodynamic control surfaces, such as flaps, spoilers, ailerons, rudders, elevators, and fins. These traditional flight control systems have numerous disadvantages. For example, these systems generally require substantial infrastructure, including hinge structures, hydraulic or pneumatic actuators, and complex under-surface fluid delivery systems to drive the actuators. This infrastructure increases vehicle complexity, thereby increasing manufacturing cost, and increases weight, thereby reducing vehicle performance.

Another disadvantage of traditional flight control systems is the relatively large surface discontinuities and level mismatches between the aerodynamic control surfaces and the adjacent air vehicle surface. That is, the control surfaces necessitate gaps between them. Further, the vehicle surface and the control surfaces are often not flush with each other. These gaps and surface level mismatches reduce vehicle performance by degrading the aerodynamic characteristics of the vehicle.

Other disadvantages of traditional flight control systems include the relatively high maintenance cost associated with repairing the complex infrastructure and the relatively slow response time to actuate the aerodynamic control surfaces for changing vehicle attitude. In addition, traditional air vehicle control systems produce relatively high amounts of unwanted aeroacoustic noise during transonic flight.

### BRIEF SUMMARY OF THE INVENTION

The present invention relates to an air vehicle comprising a fuselage, a first wing, and a second wing, wherein each wing extends laterally from the fuselage and has a leading edge, a trailing edge, a first surface extending between the edges, and a second surface extending between the edges opposite the first surface. The air vehicle further includes an upstream orifice and a downstream orifice positioned adjacent each other on at least one of the first surfaces, wherein each upstream orifice is positioned closer to the leading edge of the respective wing than the corresponding downstream orifice and each second surface is substantially free of orifices. In addition, the air vehicle includes an actuator positioned within each wing having orifices positioned thereon between the leading edge and the trailing edge and between the first surface and the second surface. Each actuator is operatively connected to the upstream and downstream orifices positioned on the respective wing for selectively creating a negative pressure differential at the corresponding upstream orifice so air adjacent the upstream orifice is drawn toward the upstream orifice and a positive pressure differential at the corresponding downstream orifice so air adjacent the downstream orifice is pushed away from the downstream orifice. The upstream orifice is configured so air moves into the upstream orifice at an angle of about 90° with respect to the first surface and the downstream orifice is configured so air moves out of the downstream orifice at an angle of about 90° with respect to the first surface.

In another aspect, the present invention includes a system for controlling the attitude of a flight vehicle having a first surface and a second surface opposite the first surface. The system includes an upstream orifice and a downstream orifice positioned in the first surface. The second surface is substantially free of orifices. The system further includes an actuator positioned between the two surfaces and operatively connected to the orifices for creating a negative pressure differential at the upstream orifice so fluid moves toward the upstream orifice and a positive pressure differential at the downstream orifice so fluid moves away from the downstream orifice. The upstream orifice is configured so air moves into the upstream orifice at an angle of about 90° with respect to the first surface and the downstream orifice is configured so air moves out of the downstream orifice at an angle of about 90° with respect to the first surface.

In yet another aspect, the present invention includes a method for controlling the attitude of an air vehicle including an airfoil having first and second surfaces, upstream and downstream orifices positioned in the first surface, and an actuator positioned in the airfoil and operatively connected to the orifices. The method includes operating the air vehicle so a transonic condition exists adjacent the airfoil. The method further includes selectively drawing air into the upstream orifice from a supersonic flow region adjacent the first surface at an angle of about 90° with the first surface and selectively directing air out of the downstream orifice and into the supersonic flow region at an angle of about 90° with the first surface. The method also includes preventing air from being drawn into or directed out of the airfoil through the second surface.

In still another aspect, the present invention includes a method for controlling the attitude of a vehicle having a first surface, a second surface opposite the first surface, and upstream and downstream orifices positioned adjacent each other in the first surface. The method comprises operating the vehicle so transonic conditions exist about the vehicle. The method further comprises selectively drawing air into the upstream orifice from a supersonic flow region adjacent the first surface at an angle of about 90° with the first surface and selectively pushing air out of the downstream orifice and into the supersonic flow region at an angle of about 90° with the first surface.

Other aspects of the present invention will be in part apparent and in part pointed out hereinafter.

### BRIEF DESCRIPTION OF THE DRAWINGS

FIG. 1 is a plan view of an air vehicle according to a first embodiment of the present invention.

FIG. 2 is a cross section of the air vehicle taken along line 2-2 of FIG. 1 showing transonic characteristics adjacent the air vehicle.

FIG. 3 is a plan view of an air vehicle according to a second embodiment of the present invention.

FIG. 4 is an enlarged cross section of a portion of the air vehicle as identified in FIG. 2.

FIG. 5 is a perspective of an air vehicle tail section according to a third embodiment of the present invention.

Corresponding reference characters indicate corresponding parts throughout the several views of the drawings.

### DETAILED DESCRIPTION OF THE INVENTION

The present invention relates to air vehicles and, more particularly, to air vehicles having an active flow control system for controlling vehicle attitude during transonic flight. Although the devices, systems, and methods for using them consistent with the present invention are primarily discussed with reference to air vehicles, they may be applied to other products (e.g., watercraft and land vehicles) without departing from the scope of the present invention.

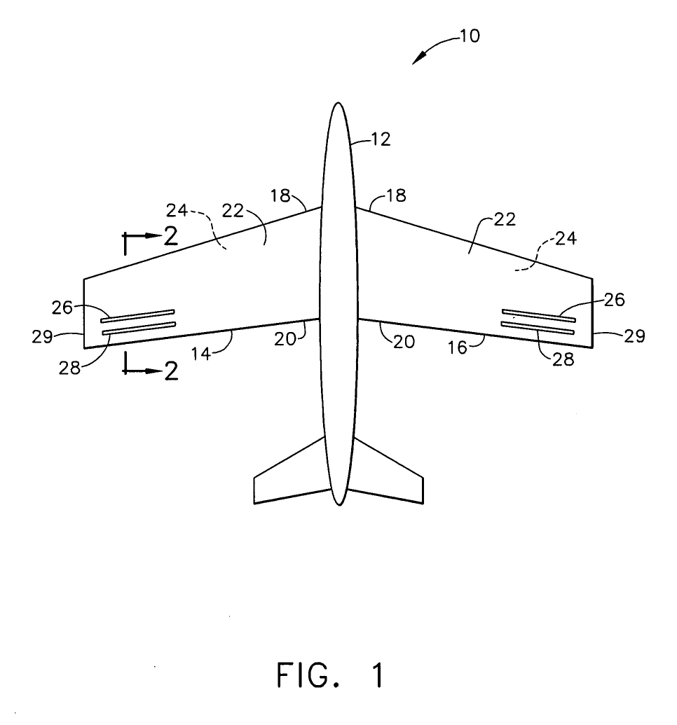

Referring now to the figures, and more particularly to FIG. 1, an air vehicle according to a first embodiment of the present invention is designated in its entirety by reference number 10. The air vehicle 10 has a fuselage 12 and opposite first and second wings 14, 16, respectively, extending laterally from the fuselage. Each wing 14, 16 has a leading edge 18, a trailing edge 20, an upper (or first) surface 22 extending between the edges, and a lower (or second) surface 24 extending between the edges below the upper surface. The air vehicle 10 further includes an upstream orifice 26 and a downstream orifice 28 positioned adjacent each other on at least one of the first surfaces 22. FIG. 1 shows orifices 26, 28 positioned on the first surface 22 of both wings 14, 16. The upstream orifice 26 is positioned closer to the leading edge 18 of the wing 14, 16 than the downstream orifice 28. Although the upstream orifice 26 may be positioned in other locations with respect to the downstream orifice 28 without departing from the scope of the present invention, in one embodiment the upstream orifice is positioned directly upstream from the downstream orifice. Although the orifices 26, 28 may have other shapes, such as circular or oval, without departing from the scope of the present invention, in one embodiment the orifices are shaped as elongate slits, as shown in FIG. 1. Although the orifices 26, 28 may have other lengths without departing from the scope of the present invention, in one embodiment each slit has a length of between about 15% of a wing 14 span and about 25% of the wing span. The span of the wing 14 is the line between tips 29 of the wings 14, 16. Although the orifices 26, 28 may have other widths without departing from the scope of the present invention, in one embodiment each slit has a width of between about 0.025 inches and about 0.055 inches. Variables affecting the lengths and widths of the orifices 26, 28 include the type of wings the orifices are disposed on. Wing types that can be used include low-profile and high-profile. Each second surface 24 is substantially free of orifices, preventing air from being drawn into or directed out of the wings 14, 16 through the second surface during operation of the air vehicle 10.

Although the orifices 26, 28 represent discontinuities in the surface 22 of the air vehicle 10, these discontinuities have less affect on vehicle aerodynamics than the effects of the discontinuities (e.g., gaps), level mismatches, and structure (e.g., hinges) associated with traditional aerodynamic control surfaces. In one embodiment, the orifices 26, 28 are used on an air vehicle (not shown) in combination with one or more conventional control surfaces. Although the first surfaces 22 are shown as upper surfaces and the second surfaces 24 are shown as lower surfaces of the wings 14, 16, the first surfaces may be the lower surfaces and the second surfaces may be the upper surfaces without departing from the scope of the present invention.

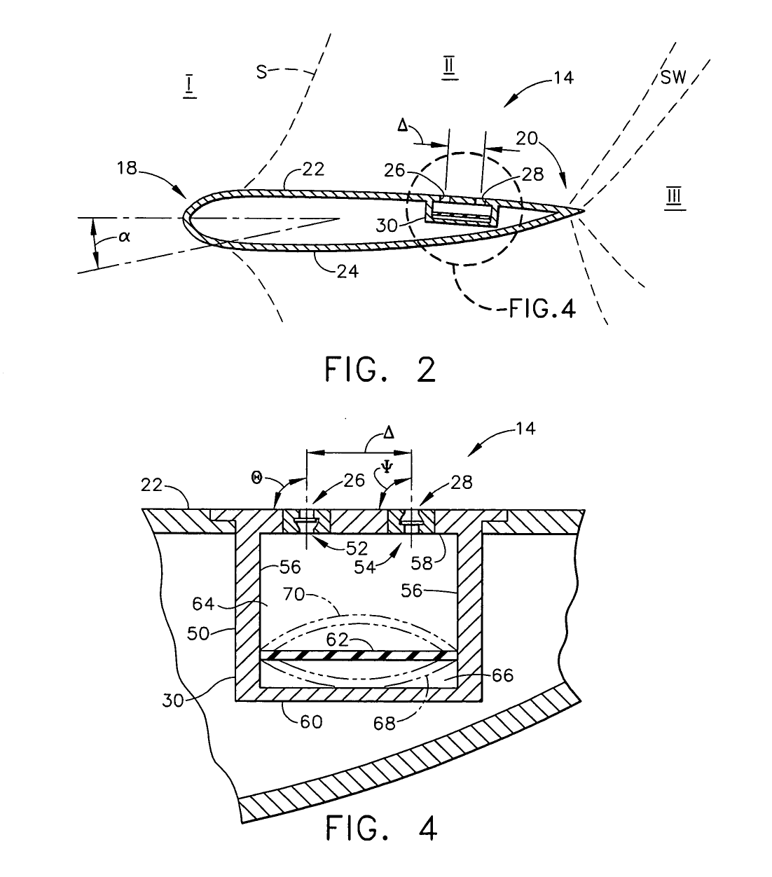

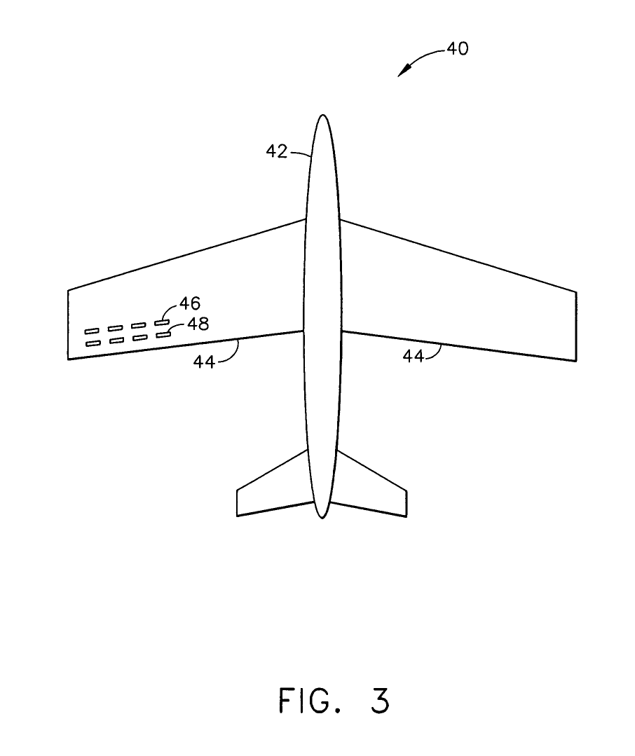

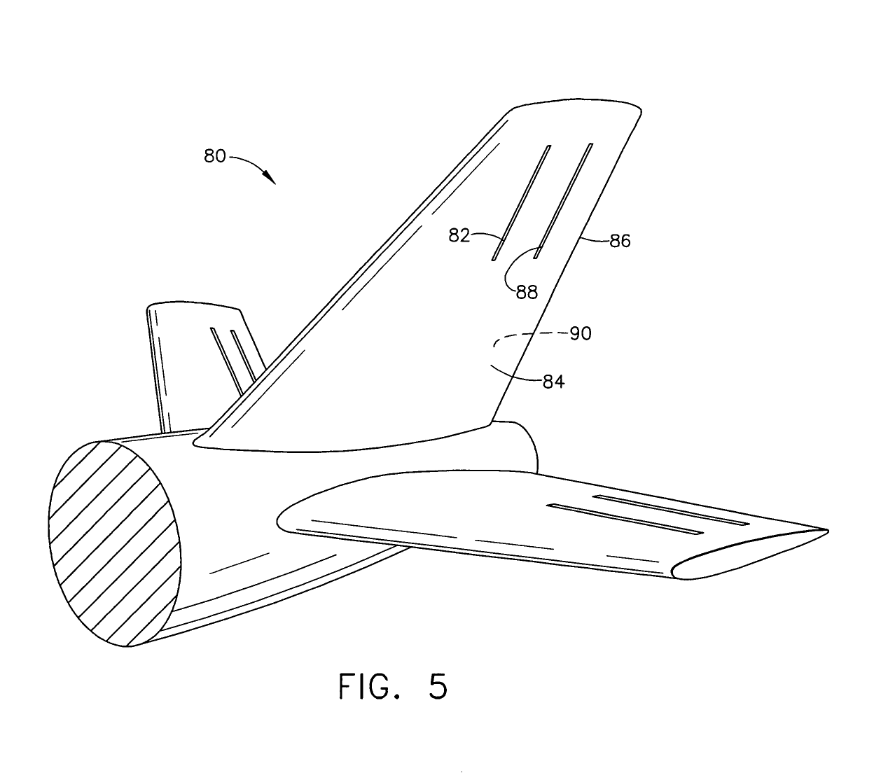

As shown in FIG. 2, the air vehicle 10 further includes an actuator 30 positioned within at least one wing 14, 16 between the leading edge 18 and the trailing edge 20 and between the first surface 22 and the second surface 24 and operatively connected to the respective upstream and downstream orifices 26, 28. Although a single actuator 30 is shown associated with a single set of orifices 26, 28, multiple actuators (not shown) may be operatively connected to a single set of slits or a single actuator may be operatively connected to multiple sets of slits. In one embodiment (not shown), one or more actuators are associated with the upstream orifice 26 and one or more separate actuators are associated with the downstream orifice 28. FIG. 3 shows an embodiment of the present invention including an air vehicle 40 having a fuselage 42, two wings 44 extending laterally from the fuselage, and multiple sets of orifices 46, 48 arrayed along at least one of the wings. The orifices 46, 48 shown are generally rectangular. The orifices 46, 48 of this embodiment may be operatively connected to one or more actuators (not shown). As shown in FIG. 4, each actuator 30 and the corresponding orifices 26, 28 may be contained in a separable drop-in unit 50. Units 50 can be dropped into one or both wings 14, 16 during manufacture or during renovation of the air vehicle 10. In one embodiment (not shown), the orifices 26, 28 are independently mounted on the wings 14, 16 and connected to the actuator 30. The actuator 30 is used to selectively create a negative pressure differential at the upstream orifice 26 so air adjacent the upstream orifice is drawn toward the upstream orifice at an angle of about 90° with the first surface and to create a positive pressure differential at the downstream orifice 28 so air adjacent the downstream orifice is pushed away from the downstream orifice at an angle of about 90° with the first surface.

A timing relationship between the drawing of air into the upstream orifice 26 and the pushing of air away from the downstream orifice 28 may be characterized by a phase differential. The drawing and pushing of air may occur in phase (i.e., 0° phase difference), completely out of phase (i.e., 180° phase difference), or anywhere between. In one embodiment, the actuator 30 is selectively operated to vary the phase differential between in phase and completely out of phase. A waveform of a velocity of air moving into the upstream orifice 26 and a waveform of a velocity of air moving out of the downstream orifice 28 with respect to time may have various shapes. In one embodiment the waveforms each have a sinusoidal shape, increasing from zero velocity to a maximum velocity and then gradually decreasing back to zero velocity. In another embodiment, the waveforms are square, quickly stepping from zero velocity to a maximum velocity, continuing at the maximum velocity, and then quickly stepping back to zero velocity.

FIG. 2 also shows aerodynamic characteristics that exist adjacent the wing 14 as it operates under transonic conditions. Transonic conditions exist when air in a first region I adjacent the leading edge 18 of the wing 14 is moving at subsonic speeds with respect to the wing, air in the second region II adjacent the wing is moving at supersonic speeds with respect to the wing, and air in a third region III adjacent the trailing edge 20 of the wing is moving at subsonic speeds with respect to the wing. A sonic line “S” extends between and separates the first region I and the second, supersonic, region II. A shock wave “SW” extends from the wing 14 adjacent the trailing edge 20 and separates the second, supersonic, region II and the third region III. Whether transonic conditions exist adjacent the wing 14 during flight depends on variables including the shape of the air vehicle 10 and a Mach number and an angle of attack α at which the air vehicle is moving. The Mach number of a moving object is the ratio of the speed of the object to the speed of sound. In one embodiment, transonic conditions exist adjacent the wing 14 when the air vehicle 10 is flown at a Mach number between about 0.55 and about 1.0. The angle of attack α of an airfoil during flight is the angle between a chord of the airfoil and a velocity vector of the airfoil. The chord is the line between the leading edge 18 and the trailing edge 20 of the wing 14 generally bisecting the wing. Although transonic conditions may exist adjacent the air vehicle 10 with other angles of attack α, in one embodiment transonic conditions exist adjacent the air vehicle when the angle of attack is between about −5° and about 5°. For example, a commercially available NACA-64A010 airfoil (not shown), transonic conditions exist adjacent the airfoil when the angle of attack α is about 2° and the Mach number is about 0.95.

The orifices 26, 28 are positioned within the supersonic flow region II and upstream of the shock wave SW when the air vehicle 10 is traveling at transonic conditions. The positions of the orifices 26, 28 can be described with respect to the chord of the wing 14. A chord position can be described by the percentage of the total chord the orifices 26, 28 lie from the leading edge 18. Although the orifices 26, 28 may be located at other chord positions without departing from the scope of the present invention, in one embodiment the upstream orifice is located at a chord position of between about 50% and about 70% and the downstream orifice is located at a chord position of between about 65% and about 90% and the downstream orifice should typically be positioned downstream of the upstream orifice. For example, for the NACA-64A010 airfoil, 53% and 68% are effective chord positions for the first and second orifices 26, 28, respectively, for implementing the present invention. As another example, in FIG. 2, the orifices 26, 28 are shown at about 68% chord and about 85% chord, respectively. As a further example, in FIG. 3, the orifices 46, 48 are shown at about 58% chord and about 91% chord, respectively. The downstream orifice 28 may be located at almost 100% chord and still be positioned adjacent the supersonic region II because the supersonic region may end at the shock wave SW, which generally extends from the trailing edge 20 of the wing 14. In one embodiment (not shown), the upstream orifice 26 is positioned at the sonic line S or in the first region I. The orifices 26, 28 can be separated by various distances without departing from the scope of the present invention. Although the space Δ between orifices 26, 28 may have other sizes, in one embodiment, the space between the orifices measures between about 15% and about 40% of the chord length. For example, for the NACA-64A010 airfoil, a space between the upstream and downstream orifices measures about 15% of the chord length.

Although the orifices 26, 28 may be configured so air is drawn toward the upstream orifice and pushed away from the downstream orifice at other angles without departing from the scope of the present invention, in one embodiment the upstream orifice is configured so the air is drawn toward the upstream orifice at an angle θ of between about 80° and about 100° with respect to the surface 22 in the region adjacent the orifice and the downstream orifice is configured so air is pushed away from the downstream orifice at an angle ψ of between about 80° and about 100° with respect to the surface in the region adjacent the orifice. As shown in FIG. 4, each orifice 26, 28 includes a one-way port or valve 52, 54, allowing air to only move into the upstream orifice through the valve 52 associated therewith and out of the downstream orifice through the valve 54 associated therewith. The one-way valves 52, 54 may be passive or active. Passive valves allow air to pass through them in one direction at a rate that depends on the pressure of the air entering the valve and valve structural variables, such as the material, weight, size, and shape of the valve. Active one-way valves allow air to pass through them in only one direction and regulate the amount of air that passes through them. For example, an active one-way valve can regulate the amount of air that passes through it by stiffening a flap around which air passes as the flap bends or by otherwise controlling the bend of the flap.

Although the actuator 30 may be other types without departing from the scope of the present invention, in one embodiment, the actuator is a piezoelectric actuator. Other actuator types usable in the present invention include pneumatic, electromagnetic, and other electromechanical actuators, such as those including a cam or piston (not shown). A benefit of using these actuators is quick response time compared to traditional flight control systems. The actuator 30 shown in FIG. 4 includes sides 56, a top 58, and a bottom 60. Adjacent the bottom 60 is a diaphragm, bellow, or membrane 62. The top 58 includes the valves 52, 54. The sides 56, top 58, and membrane 62 define a first chamber 64 therebetween. Below the membrane 62 is a second chamber 66. Although the first chamber 64 is shown being adjacent to the valves 52, 54, it is contemplated that the first chamber may be connected to the valves by way of pipes or passages.

The membrane 62 is made of a flexible material that allows the membrane to flex between a concave position 68 and a convex position 70. As will be appreciated by those skilled in the art, when the actuator 30 is a piezoelectric actuator, the membrane 62 moves between the concave and convex positions 68, 70 in response to electrical currents applied to the membrane. The membrane 62 can be intermittently moved between its concave and convex positions 68, 70 to intermittently create a negative pressure at the upstream orifice 26 and a positive pressure at the downstream orifice 28. When the membrane 62 moves toward the concave position 68, pressure within the first chamber 64 decreases to a pressure lower than an ambient pressure of air outside of the wing 14 adjacent the orifices 26, 28. Thus, air exterior to the wing 14 and adjacent the upstream orifice 26 is drawn toward and through the one-way valve 52 associated with the upstream orifice. When the membrane 62 moves toward the convex position 70, pressure within the chamber 64 increases to a pressure higher than an ambient pressure of air outside of the wing 14 adjacent the orifices 26, 28. Thus, air within the first chamber 64 is pushed through and away from the one-way valve 54 associated with the downstream orifice 28. As described above, the upstream orifice 26 can be configured so air is drawn to it normal (i.e., at 90°) to the adjacent first surface 22 and the downstream orifice 28 can be configured so the air is pushed away from it normal to the first surface.

The actuator 30 may be vented (not shown) to facilitate movement of the membrane 62. For example, without venting, air pressure in the second chamber 66 is greatly increased as the membrane 62 attempts to move toward the concave position 68. The electrically actuated membrane 62 must move with a force sufficient to contract the air in the second chamber 66 enough to allow the membrane 62 to reach the concave position 68. Further, air accelerating through the supersonic region II over the wing 14 creates a negative pressure on the outside of the wing adjacent the orifices 26, 28. Thus, with a non-vented actuator, the membrane 62 must work against the increasing force resulting from the increasing pressure in the second chamber 66 and the opposite force resulting from the negative pressure differential above the wing surface 22 as it moves towards its concave position 68. These two forces impede actuator operation and may render it inoperable. Venting the actuator 30 allows free movement of the membrane 62 by balancing relative pressures. As will be appreciated by those skilled in the art, the actuator 30 may be vented in a variety of ways.

The membrane 62 can be continuously moved between its concave and convex positions 68, 70 with a desired frequency to create a pulsing or periodic effect. Although the actuator 30 may operate at other frequencies without departing from the scope of the present invention, in one embodiment the actuator 30 operates at a frequency of between about 150 Hz and about 350 Hz. As will be appreciated by those skilled in the art, the amount and force of the air being drawn into and directed out of the actuator 30 depends on the configuration of the actuator, including the size of the membrane 62, and the intensity with which the membrane is displaced. The air being drawing into and directed out of the actuator 30 affects air vehicle flight by affecting the air traveling over the surface 22 of the wing 14. The force, volume, and frequency at which the actuator 30 draws and pushes air determines how the actuator affects the air traveling over the wing 14 and thus the flight of the air vehicle. The primary flight characteristics affected by the actuator 30 are lift, drag, and moments.

Having orifices 26, 28 instead of traditional control surfaces (not shown) reduces aeroacoustic noise, such as cabin noise, by lowering the size and number of gaps in the surfaces 22, 24 of the wings 14, 16 and substantially eliminating level differences on those surfaces. Further, aeroacoustic noise that may result from shock waves during flight at transonic speeds can be attenuated through selective operation of the actuator 30. For example, characteristics (e.g., the path) of the air traveling adjacent the wing 14 can be changed to reduce the aeroacoustic noise associated with the shock wave.

The flight system, including the actuator 30 and two orifices 26, 28, is referred to as a dual point air flow control system because flight conditions can be controlled using these components. The particular force, volume, and frequency necessary to create particular changes in air vehicle 10 flight depends on geometries of the airfoil and flight conditions, such as the angle of attack α and Mach number at which the air vehicle is moving. Thus, all of these can be adjusted to control air vehicle attitude and/or attenuate aeroacoustic noise during flight. The actuator 30 may be operated to move the shock wave in a predetermined manner to control vehicle attitude. Further regarding attitude control, depending on airfoil geometries and flight conditions, the force, amount, and frequency of air pulsed in and out of the orifices 26, 28 can affect lift, drag, side forces, and/or moments (i.e., yaw, pitch, and roll) experienced by the airfoil. These forces and/or moments are controlled by controlling the shape of the aerodynamic characteristics passing adjacent the airfoil. In one embodiment, the amount and force of air passing through the orifices 26, 28 remain generally constant. In this embodiment, the frequency at which the actuator 30 is operated and changes to the frequency primarily determine the affects the actuator 30 has on the aerodynamic characteristics of the airfoil at any given angle of attack α and Mach number. In embodiments where orifices 26, 28 and an actuator 30 are employed on only one wing 14 of a dual wing air vehicle 10, vehicle roll can be controlled by increasing or decreasing the amount of lift on that wing 14. In embodiments where orifices 26, 28 and an actuator 30 are employed on both wings 14, 16, the vehicle can be rolled by increasing or decreasing the lift on either of the wings 14, 16 by simultaneously increasing the lift on one of the wings 14, 16 and decreasing the lift on the other wing 16, 14, or by affecting a lift differential between the wings. In embodiments where orifices 26, 28 and an actuator 30 are employed on only one wing 14 of a dual wing air vehicle 10, vehicle yaw can be controlled by increasing or decreasing the amount of drag on that wing 14. In embodiments where orifices 26, 28 and an actuator 30 are employed on both wings 14, 16, the vehicle can be yawed by increasing or decreasing the drag on either of the wings 14, 16 by simultaneously increasing the drag on one of the wings 14, 16 and decreasing the drag on the other wing 16, 14, or by affecting a drag differential between the wings. Air may also be selectively drawn into the upstream orifice 26 and directed out of the downstream orifice 28 to control pitch. For example, the actuator 30 may be selectively operated to create a level differential between the leading edge and trailing edge of the wings thereby controlling vehicle pitch.

Application of the present invention is not limited to use on air vehicles 10 having fixed wings 14, 16. For example, orifices can be positioned on other air vehicle surfaces (e.g., aircraft or missile fuselage surfaces) and on rotor blades. FIG. 5 shows an air vehicle 80 according to the present invention having a generally vertical upstream orifice 82 positioned on a first side surface 84 of a vertical tail 86 of the air vehicle and a downstream orifice 88 positioned on the first side surface substantially parallel to the upstream orifice. As with the first embodiment, a second surface 90 opposite the first surface 84 is substantially free of orifices, which prevents air from being drawn into or directed out of the tail 86 through the second surface. The structure and function for this embodiment can otherwise be the same as any of the earlier described embodiments and therefore will not be described in further detail.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. An air vehicle comprising:
a fuselage;
a first wing and a second wing, each wing extending laterally from the fuselage and having a leading edge, a trailing edge, a first surface extending between the edges, and a second surface extending between the edges opposite the first surface;
an upstream orifice and a downstream orifice positioned adjacent each other on at least one of the first surfaces, each upstream orifice being positioned closer to the leading edge of the respective wing than the corresponding downstream orifice, each second surface being substantially free of orifices; and
an actuator positioned within each wing having orifices positioned thereon between the leading edge and the trailing edge and between the first surface and the second surface and operatively connected to the upstream and downstream orifices positioned on the respective wing for selectively creating a negative pressure differential at the corresponding upstream orifice so air adjacent the upstream orifice is drawn toward the upstream orifice and a positive pressure differential at the corresponding downstream orifice so air adjacent the downstream orifice is pushed away from the downstream orifice;
wherein each upstream orifice is configured so the air is drawn toward the upstream orifice at an angle of about 90° with respect to the corresponding first surface and each downstream orifice is configured so the air is pushed away from the downstream orifice at an angle of about 90° with respect to the corresponding first surface.

2. An air vehicle as set forth in claim 1 wherein the first surface is a top surface and the second surface is a bottom surface of the respective wing.

3. An air vehicle as set forth in claim 1 wherein each orifice includes a one-way valve such that air can only move into the upstream orifice through the valve associated therewith and air can only move out of the downstream orifice through the valve associated therewith.

4. An air vehicle as set forth in claim 1 wherein the orifices are positioned within a region of supersonic flow when the vehicle is traveling at transonic conditions.

5. An air vehicle as set forth in claim 1 wherein each orifice includes an elongated slit in said first surface.

6. An air vehicle as set forth in claim 1 wherein each actuator is vented.

7. An air vehicle as set forth in claim 1 wherein each upstream orifice is positioned directly upstream from the corresponding downstream orifice.

8. A system for controlling the attitude of a flight vehicle having a first surface and a second surface opposite the first surface, the system comprising:
an upstream orifice and a downstream orifice positioned in the first surface, the second surface being substantially free of orifices; and
an actuator positioned between the two surfaces and operatively connected to the orifices for creating a negative pressure differential at the upstream orifice so fluid moves toward the upstream orifice and a positive pressure differential at the downstream orifice so fluid moves away from the downstream orifice;
wherein the upstream orifice is configured so air moves into the upstream orifice at an angle of about 90° with respect to the first surface and the downstream orifice is configured so air moves out of the downstream orifice at an angle of about 90° with respect to the first surface.

9. A system as set forth in claim 8 wherein the actuator is vented.

10. A system as set forth in claim 8 wherein the first surface is a top surface of the vehicle and the second surface is a bottom surface of the vehicle.

11. A system as set forth in claim 8 wherein the first and second surfaces are side surfaces of the vehicle.

12. A system as set forth in claim 8 wherein each orifice includes an elongated slit in the first surface.

13. A system as set forth in claim 8 wherein each orifice includes a one-way valve such that air can only move into the upstream orifice through the valve associated therewith and air can only move out of the downstream orifice through the valve associated therewith.

14. A method for controlling the attitude of an air vehicle including an airfoil having first and second surfaces, upstream and downstream orifices positioned in the first surface, and an actuator positioned in the airfoil and operatively connected to the orifices, the method comprising:
operating the vehicle so a transonic condition exists adjacent the airfoil;
selectively drawing air into the upstream orifice from a supersonic flow region adjacent the first surface at an angle of about 90° with said first surface;
selectively directing air out of the downstream orifice and into the supersonic flow region at an angle of about 90° with said first surface; and
preventing air from being drawn into or directed out of the airfoil through the second surface.

15. A method for controlling the attitude of an air vehicle as set forth in claim 14 wherein at least one of vehicle lift and roll is controlled by selectively drawing air into the upstream orifice and selectively directing air out of the downstream orifice.

16. A method for controlling the attitude of an air vehicle as set forth in claim 14 wherein noises resulting from shock waves are attenuated by selectively drawing air into the upstream orifice and selectively directing air out of the downstream orifice.

17. A method for controlling the attitude of an air vehicle as set forth in claim 14 wherein the operating step includes flying the vehicle at a Mach number between about 0.55 and about 1.0.

18. A method for controlling the attitude of a vehicle having a first surface, a second surface opposite the first surface, and upstream and downstream orifices positioned adjacent each other in the first surface, the method comprising:
operating the vehicle so transonic conditions exist about the vehicle;
selectively drawing air into the upstream orifice from a supersonic flow region adjacent the first surface at an angle of about 90° with said first surface; and
selectively pushing air out of the downstream orifice and into the supersonic flow region at an angle of about 90° with said first surface.

19. A method for controlling the attitude of a vehicle as set forth in claim 18 wherein the vehicle is a missile and the missile is operated so transonic conditions exist about the missile.

20. A method for controlling the attitude of a vehicle as set forth in claim 18 wherein said selective drawing and pushing of air into the upstream orifice and out of the downstream orifice, respectively, is performed to control vehicle lift.

21. A method for controlling the attitude of a vehicle as set forth in claim 18 wherein said selective drawing and pushing of air into the upstream orifice and out of the downstream orifice, respectively, is performed to control vehicle drag.

22. A method for controlling the attitude of a vehicle as set forth in claim 18 wherein said selective drawing and pushing of air into the upstream orifice and out of the downstream orifice, respectively, is performed to control vehicle side forces.

23. A method for controlling the attitude of a vehicle as set forth in claim 18 wherein said selective drawing and pushing of air into the upstream orifice and out of the downstream orifice, respectively, is performed to control vehicle roll.

24. A method for controlling the attitude of a vehicle as set forth in claim 18 wherein said selective drawing and pushing of air into the upstream orifice and out of the downstream orifice, respectively, is performed to control vehicle yaw.

25. A method for controlling the attitude of a vehicle as set forth in claim 18 wherein said selective drawing and pushing of air into the upstream orifice and out of the downstream orifice, respectively, is performed to control vehicle pitch.

26. A method for controlling the attitude of a vehicle as set forth in claim 18 wherein the vehicle further has a leading edge and a trailing edge and a shock wave extends from the vehicle adjacent said trailing edge during transonic flight and the method further comprises positioning the downstream orifice adjacent and upstream of said shock wave and positioning the upstream orifice upstream of the downstream orifice.
